(19) United States
(12) Patent Application Publication
(10) Pub. No.: US 2015/0143798 A1
(43) Pub. Date: May 28, 2015

(54) SYSTEM AND METHOD OF PURIFYING EXHAUST GAS

(71) Applicant: Hyundai Motor Company, Seoul (KR)

(72) Inventor: Jin Ha LEE, Seoul (KR)

(73) Assignee: Hyundai Motor Company, Seoul (KR)

(21) Appl. No.: 14/225,075

(22) Filed: Mar. 25, 2014

(30) Foreign Application Priority Data
Nov. 22, 2013 (KR) 10-2013-0143254

(51) Int. Cl. F02D 41/14; F01N 3/20

(52) U.S. Cl. CPC F02D 41/1446; F01N 3/208
USPC 60/274; 60/297; 60/285

(57) ABSTRACT

A system of purifying exhaust gas may include an engine including an injector, a lean NOx trap (LNT) adapted to absorb nitrogen oxide (NOx) contained in the exhaust gas at a lean air/fuel ratio, to release the absorbed nitrogen oxide at a rich air/fuel ratio, and to reduce the nitrogen oxide contained in the exhaust gas or the released nitrogen oxide, a dosing module adapted to inject reducing agent into the exhaust gas, a selective catalytic reduction catalyst on a diesel particulate filter (SDPF) adapted to trap particulate matter and to reduce the nitrogen oxide using the reducing agent injected through the dosing module, and a controller performing denitrification (DeNOx) using the LNT when temperature of the exhaust gas may be lower than transient temperature, and performing denitrification using the SDPF when the temperature of the exhaust gas may be higher than or equal to the transient temperature.

### CROSS-REFERENCE TO RELATED APPLICATION

The present application claims priority to Korean Patent Application No. 10-2013-0143254 filed on Nov. 22, 2013, the entire contents of which is incorporated herein for all purposes by this reference.

### BACKGROUND OF THE INVENTION

1. Field of the Invention

The present invention relates to a system and a method of purifying exhaust gas, and more particularly, to a system and a method of purifying exhaust gas that can improve purifying efficiency of nitrogen oxide under all the driving conditions.

2. Description of Related Art

Generally, exhaust gas flowing out from an engine through an exhaust manifold is driven into a catalytic converter mounted at an exhaust pipe and is purified therein. After that, the noise of the exhaust gas is decreased while passing through a muffler and then the exhaust gas is emitted into the air through a tail pipe. The catalytic converter purifies pollutants contained in the exhaust gas. In addition, a particulate filter for trapping particulate matter (PM) contained in the exhaust gas is mounted in the exhaust pipe.

A denitrification catalyst (DeNOx catalyst) is one type of such a catalytic converter and purifies nitrogen oxide (NOx) contained in the exhaust gas. If reducing agents such as urea, ammonia, carbon monoxide, and hydrocarbon (HC) are supplied to the exhaust gas, the NOx contained in the exhaust gas is reduced in the DeNOx catalyst through oxidation-reduction reaction with the reducing agents.

Recently, a lean NOx trap (LNT) catalyst is used as such a DeNOx catalyst. The LNT catalyst absorbs the NOx contained in the exhaust gas when air/fuel ratio is lean, and releases the absorbed NOx and reduces the released nitrogen oxide and the nitrogen oxide contained in the exhaust gas when the air/fuel ratio is rich atmosphere.

If temperature of the exhaust gas, however, is high (e.g., the temperature of the exhaust gas is higher than 400° C.), the LNT cannot purify the nitrogen oxide contained in the exhaust gas. Particularly, if a particulate filter for trapping particulate matter (PM) contained in the exhaust gas is regenerated or sulfur poisoning the LNT is removed, the temperature of the exhaust gas increases very highly. Therefore, the nitrogen oxide contained in the exhaust gas is not purified but is exhausted to the exterior of the vehicle.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a system and a method of purifying exhaust gas having advantages of improving purifying efficiency of nitrogen oxide under all the driving conditions by differentiating DeNOx mechanism according to temperature of the exhaust gas.

A system of purifying exhaust gas may include an engine including an injector for injecting fuel thereinto, generating power by burning mixture of air and the fuel, and exhausting the exhaust gas generated at combustion process to an exterior thereof through an exhaust pipe, a lean NOx trap (LNT) mounted on the exhaust pipe, and adapted to absorb nitrogen oxide (NOx) contained in the exhaust gas at a lean air/fuel ratio, to release the absorbed nitrogen oxide at a rich air/fuel ratio, and to reduce the nitrogen oxide contained in the exhaust gas or the released nitrogen oxide, a dosing module mounted on the exhaust pipe and adapted to inject a reducing agent into the exhaust gas, a selective catalytic reduction catalyst on a diesel particulate filter (SDPF) mounted on the exhaust pipe downstream of the dosing module and adapted to trap particulate matter contained in the exhaust gas and to reduce the nitrogen oxide contained in the exhaust gas using the reducing agent injected through the dosing module, and a controller performing denitrification (DeNOx) using the LNT when temperature of the exhaust gas is lower than transient temperature, and performing denitrification using the SDPF when the temperature of the exhaust gas is higher than or equal to the transient temperature.

The controller is adapted to control the air/fuel ratio to be rich so as for the LNT to remove the nitrogen oxide when the temperature of the exhaust gas is lower than the transient temperature and NOx amount absorbed in the LNT is greater than or equal to predetermined NOx amount.

The controller controls the dosing module to inject the reducing agent when the temperature of the exhaust gas reaches urea conversion temperature such that the reducing agent is absorbed in the SDPF.

Amount of the reducing agent injected by the dosing module is determined based on inside temperature of the SDPF, amount of the reducing agent absorbed in the SDPF, absorbing/oxidizing characteristics of the reducing agent according to the inside temperature of the SDPF, releasing characteristics of the reducing agent according to the inside temperature of the SDPF, and NOx slip characteristics of the LNT under a condition where the air/fuel ratio of the engine is controlled to be rich so as to release/reduce the NOx absorbed in the LNT.

The controller controls the air/fuel ratio to be rich close to stoichiometric air/fuel ratio when the temperature of the exhaust gas is higher than or equal to the transient temperature so as to release the NOx absorbed in the LNT, and controls the dosing module to inject the reducing agent so as to reduce the NOx released from the LNT or the NOx contained in the exhaust gas in the SDPF.

Amount of the reducing agent injected by the dosing module is determined based on inside temperature of the SDPF, amount of the reducing agent absorbed in the SDPF, absorbing/oxidizing characteristics of the reducing agent according to the inside temperature of the SDPF, releasing characteristics of the reducing agent according to the inside temperature of the SDPF, and NOx slip characteristics of the LNT according to a driving condition at the rich air/fuel ratio.

The controller is adapted to raise the temperature of the exhaust gas so as to perform regeneration of the SDPF and to control the dosing module to inject the reducing agent so as for the SDPF to reduce the NOx contained in the exhaust gas when the regeneration of the SDPF is necessary.

Amount of the reducing agent injected by the dosing module is determined based on inside temperature of the SDPF, amount of the reducing agent absorbed in the SDPF, absorbing/oxidizing characteristics of the reducing agent according to the inside temperature of the SDPF, releasing characteristics of the reducing agent according to the inside temperature of the SDPF, NOx slip characteristics of the LNT according to a driving condition and the temperature of the exhaust gas at the rich air/fuel ratio, and NOx exhaust amount from the LNT when regenerating the SDPF.

The controller is adapted to perform desulfurization of the LNT by repeating the rich air/fuel ratio and the lean air/fuel ratio and to control the dosing module to inject the reducing agent so as for the SDPF to reduce the NOx contained in the exhaust gas when the desulfurization of the LNT is necessary.

Amount of the reducing agent injected by the dosing module is determined based on inside temperature of the SDPF, amount of the reducing agent absorbed in the SDPF, absorbing/oxidizing characteristics of the reducing agent according to the inside temperature of the SDPF, releasing characteristics of the reducing agent according to the inside temperature of the SDPF, NOx slip characteristics of the LNT according to a driving condition at the rich air/fuel ratio, and NOx exhaust amount from the LNT when desulfurizing the LNT.

The system may further include a mixer mounted on the exhaust pipe between the dosing module and the SDPF and mixing the reducing agent and the exhaust gas evenly.

The SDPF may further include an additional selective catalytic reduction catalyst (SCR) for reducing the nitrogen oxide contained in the exhaust gas using the reducing agent injected by the dosing module.

In another aspect of the present invention, a method of purifying exhaust gas may include detecting temperature of the exhaust gas, comparing the temperature of the exhaust gas with transient temperature, removing nitrogen oxide contained in the exhaust gas at a lean NOx trap (LNT) by controlling combustion environment when the temperature of the exhaust gas is lower than the transient temperature, and removing the nitrogen oxide contained in the exhaust gas at a diesel particulate filter (SDPF) by injecting reducing agent when the temperature of the exhaust gas is higher than or equal to the transient temperature.

The removal of the nitrogen oxide contained in the exhaust gas at the LNT is performed by controlling air/fuel ratio to be rich when NOx amount absorbed in the LNT is greater than or equal to predetermined NOx amount.

The removal of the nitrogen oxide contained in the exhaust gas at the LNT, before controlling the air/fuel ratio to be rich, may further include determining whether the temperature of the exhaust gas reaches urea conversion temperature, determining target injection amount of the reducing agent when the temperature of the exhaust gas reaches the urea conversion temperature, and injecting the reducing agent according to the target injection amount of the reducing agent.

The target injection amount of the reducing agent is determined based on inside temperature of the SDPF, amount of the reducing agent absorbed in the SDPF, absorbing/oxidizing characteristics of the reducing agent according to the inside temperature of the SDPF, releasing characteristics of the reducing agent according to the inside temperature of the SDPF, and NOx slip characteristics of the LNT under a condition where the air/fuel ratio of the engine is controlled to be rich so as to release/reduce the NOx absorbed in the LNT.

The removal of the nitrogen oxide contained in the exhaust gas at the SDPF may include determining target injection amount of the reducing agent based on inside temperature of the SDPF, amount of the reducing agent absorbed in the SDPF, absorbing/oxidizing characteristics of the reducing agent according to the inside temperature of the SDPF, releasing characteristics of the reducing agent according to the inside temperature of the SDPF, and NOx slip characteristics of the LNT according to a driving condition at the rich air/fuel ratio, and injecting the reducing agent according to the target injection amount of the reducing agent.

The removal of the nitrogen oxide contained in the exhaust gas at the SDPF, before determining the target injection amount of the reducing agent, may further include determining whether regeneration of the SDPF is necessary, and performing the regeneration of the SDPF when the regeneration of the SDPF is necessary, wherein the target injection amount of the reducing agent is determined by further considering NOx exhaust amount from the LNT when regenerating the SDPF.

The removal of the nitrogen oxide contained in the exhaust gas at the SDPF, before determining the target injection amount of the reducing agent, may further include determining whether desulfurization of the LNT is necessary, and performing the desulfurization of the LNT when the desulfurization of the LNT is necessary, wherein the target injection amount of the reducing agent is determined by further considering NOx exhaust amount from the LNT when desulfurizing the LNT.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic diagram of a system of purifying exhaust gas according to an exemplary embodiment of the present invention.

FIG. 2 is a block diagram illustrating a relationship of an input and output of a controller used in a method of purifying exhaust gas according to an exemplary embodiment of the present invention.

FIG. 3 is a flowchart of a method of purifying exhaust gas according to an exemplary embodiment of the present invention.

FIG. 4 is a flowchart of a DeNOx method using an LNT in a method of purifying exhaust gas according to an exemplary embodiment of the present invention.

FIG. 5 is a flowchart of a DeNOx method using an SDPF in a method of purifying exhaust gas according to an exemplary embodiment of the present invention.

FIG. 6 is a block diagram of a method of calculating target injection amount of urea in a method of purifying exhaust gas according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

An exemplary embodiment of the present invention will hereinafter be described in detail with reference to the accompanying drawings.

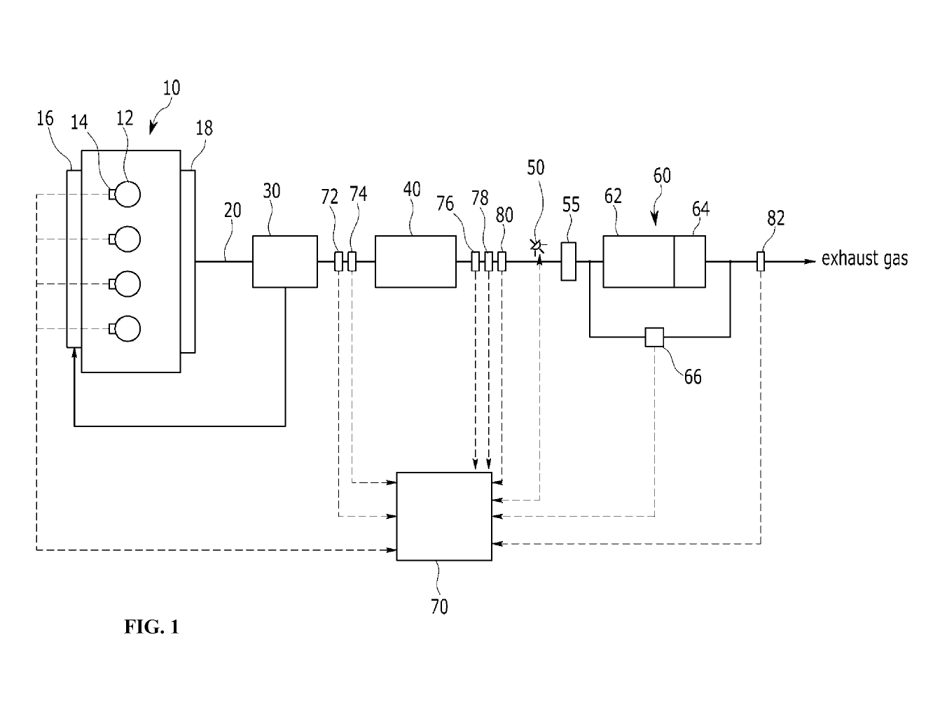

FIG. 1 is a schematic diagram of a system of purifying exhaust gas according to an exemplary embodiment of the present invention.

As shown in FIG. 1, an exhaust system for an internal combustion engine includes an engine 10, an exhaust pipe 20, an exhaust gas recirculation (EGR) apparatus 30, a lean NOx trap (LNT) 40, a dosing module 50, a particulate filter 60, and a controller 70.

The engine 10 burns air/fuel mixture in which fuel and air are mixed so as to convert chemical energy into mechanical energy. The engine 10 is connected to an intake manifold 16 so as to receive the air in a combustion chamber 12, and is connected to an exhaust manifold 18 such that exhaust gas generated in combustion process is gathered in the exhaust manifold 18 and is exhausted to the exterior. An injector 14 is mounted in the combustion chamber 12 so as to inject the fuel into the combustion chamber 12.

A diesel engine is exemplified herein, but a lean-burn gasoline engine may be used. In a case that the gasoline engine is used, the air/fuel mixture flows into the combustion chamber 12 through the intake manifold 16, and a spark plug is mounted at an upper portion of the combustion chamber 12. In addition, if a gasoline direct injection (GDI) engine is used, the injector 14 is mounted at the upper portion of the combustion chamber 12.

In addition, the engines having various compression ratios, preferably a compression ratio lower than or equal to 16.5, may be used.

The exhaust pipe 20 is connected to the exhaust manifold 18 so as to exhaust the exhaust gas to the exterior of a vehicle. The LNT 40, the dosing module 50, and the particulate filter 60 are mounted on the exhaust pipe 20 so as to remove hydrocarbon, carbon monoxide, particulate matter, and nitrogen oxide contained in the exhaust gas.

The exhaust gas recirculation apparatus 30 is mounted on the exhaust pipe 20, and a portion of the exhaust gas exhausted from the engine 10 is supplied back to the engine 10 through the exhaust gas recirculation apparatus 30. In addition, the exhaust gas recirculation apparatus 30 is connected to the intake manifold 16 so as to control combustion temperature by mixing a portion of the exhaust gas with the air. Such control of the combustion temperature is performed by controlling amount of the exhaust gas supplied back to the intake manifold 16 by control of the controller 70. Therefore, a recirculation valve controlled by the controller 70 may be mounted on a line connecting the exhaust gas recirculation apparatus 30 and the intake manifold 16.

A first oxygen sensor 72 is mounted on the exhaust pipe 20 downstream of the exhaust gas recirculation apparatus 30. The first oxygen sensor 72 detects oxygen amount in the exhaust gas passing through the exhaust gas recirculation apparatus 30 and transmits a signal corresponding thereto to the controller 70 so as to help lean/rich control of the exhaust gas performed by the controller 70. In this specification, the detected value by the first oxygen sensor 72 is called air/fuel ratio (lambda) at an upstream of the LNT.

In addition, a first temperature sensor 74 is mounted on the exhaust pipe 20 downstream of the exhaust gas recirculation apparatus 30 and detects temperature of the exhaust gas passing through the exhaust gas recirculation apparatus 30.

The LNT 40 is mounted on the exhaust pipe 20 downstream of the exhaust gas recirculation apparatus 30. The LNT 40 absorbs the nitrogen oxide (NOx) contained in the exhaust gas at a lean air/fuel ratio, and releases the absorbed nitrogen oxide and reduces the nitrogen oxide contained in the exhaust gas or the released nitrogen oxide at a rich air/fuel ratio. In addition, the LNT 40 may oxidize carbon monoxide (CO) and hydrocarbon (HC) contained in the exhaust gas.

Herein, the hydrocarbon represents all compounds including carbon and hydrogen contained in the exhaust gas and the fuel.

A second oxygen sensor 76, a second temperature sensor 78, and a first NOx sensor 80 are mounted on the exhaust pipe 20 downstream of the LNT 40.

The second oxygen sensor 76 detects oxygen amount contained in exhaust gas flowing into the particulate filter 60 and transmits a signal corresponding thereto to the controller 70. The controller 70 may perform the lean/rich control of the exhaust gas based on the detected values by the first oxygen sensor 72 and the second oxygen sensor 76. In this specification, the detected value by the second oxygen sensor 62 is called air/fuel ratio (lambda) at an upstream of the filter.

The second temperature sensor 78 detects temperature of the exhaust gas flowing into the particulate filter 60 and transmits a signal corresponding thereto to the controller 70.

The first NOx sensor 80 detects NOx amount contained in the exhaust gas flowing into the particulate filter 60 and transmits a signal corresponding thereto to the controller 70. The NOx amount detected by the first NOx sensor 80 may be used to determine amount of reducing agent injected by the dosing module 50.

The dosing module 50 is mounted on the exhaust pipe 20 upstream of the particulate filter 60 and injects the reducing agent into the exhaust gas by control of the controller 70. Typically, the dosing module 50 injects urea and the injected urea is hydrolyzed and converted into ammonia. However, the reducing agent is not limited to the ammonia. For convenience of explanation, it is exemplified hereinafter that the ammonia is used as the reducing agent and the dosing module 50 injects the urea. However, it is to be understood that the reducing agent other than the ammonia is also included within the scope of the present invention without changing the spirit of the present invention.

A mixer 55 is mounted on the exhaust pipe 20 downstream of the dosing module 50 and mixes the reducing agent and the exhaust gas evenly.

The particulate filter 60 is mounted on the exhaust pipe downstream of the mixer 55, traps particulate matter contained in the exhaust gas, and reduces the nitrogen oxide contained in the exhaust gas using the reducing agent injected by the dosing module 50. For these purposes, the particulate filter 60 includes a selective catalytic reduction catalyst on a diesel particulate filter (SDPF) 62 and an additional selective catalytic reduction catalyst (SCR) 64.

The SDPF 62 is formed by coating the SCR on walls defining channels of the DPF. Generally, the DPF includes a plurality of inlet channels and outlet channels. Each of the inlet channels includes an end that is open and another end that is blocked, and receives the exhaust gas from a front end of the DPF. In addition, each of the outlet channels includes an end that is blocked and another end that is open, and discharges the exhaust gas from the DPF. The exhaust gas flowing into the DPF through the inlet channels enters the outlet channels through porous walls separating the inlet channels and the outlet channels. After that, the exhaust gas is discharged from the DPF through the outlet channels. When the exhaust gas passes through the porous walls, the particulate matter contained in the exhaust gas is trapped. In addition, the SCR coated on the SDPF 62 reduces the nitrogen oxide contained in the exhaust gas using the reducing agent injected by the dosing module 50.

The additional SCR 64 is mounted at the rear of the SDPF 62. The additional SCR 64 further reduces the nitrogen oxide if the SDPF 62 purifies the nitrogen oxide completely.

Meanwhile, a pressure difference sensor 66 is mounted on the exhaust pipe 20. The pressure difference sensor 66 detects pressure difference between a front end portion and a rear end portion of the particulate filter 60, and transmits a signal corresponding thereto to the controller 70. The controller 70 may control the particulate filter 60 to be regenerated if the pressure difference detected by the pressure difference sensor 66 is greater than predetermined pressure. In this case, the injector 14 post-injects the fuel so as to burn the particulate matter trapped in the particulate filter 60.

In addition, a second NOx sensor 82 is mounted on the exhaust pipe 20 downstream of the particulate filter 60. The second NOx sensor 82 detects amount of the nitrogen oxide contained in the exhaust gas exhausted from the particulate filter 60, and transmits a signal corresponding thereto to the controller 70. The controller 70 can check based on the detected value by the second NOx sensor 82 whether the nitrogen oxide contained in the exhaust gas is normally removed in the particulate filter 60. That is, the second NOx sensor 82 may be used to evaluate performance of the particulate filter 60.

The controller 70 determines a driving condition of the engine based on the signals transmitted from each sensor, and performs the leans/rich control and controls the amount of the reducing agent injected by the dosing module 50 based on the driving condition of the engine. For example, the controller 70 controls the LNT 40 to remove the nitrogen oxide through the lean/rich control if the temperature of the exhaust gas is lower than transient temperature, and controls the particulate filter 60 to remove the nitrogen oxide by injecting the reducing agent if the temperature of the exhaust gas is higher than or equal to the transient temperature. The lean/rich control may be performed by controlling fuel amount injected by the injector 14.

Meanwhile, the controller 70 calculates inside temperature of the SPDF 62, ammonia amount absorbed in the SDPF 62, NOx exhaust amount from the LNT 40 in desulfurization, NOx exhaust amount from the LNT 40 in regeneration of the particulate filter 60, and so on the driving condition of the engine. For these purposes, absorbing/oxidizing characteristics of the ammonia according to the inside temperature of the particulate filter 60, releasing characteristics of the ammonia according to the inside temperature of the particulate filter 60, NOx slip characteristics of the LNT 40 at the rich air/fuel ratio, and so on are stored in the controller 70. The absorbing/oxidizing characteristics of the ammonia according to the inside temperature of the particulate filter 60, the releasing characteristics of the ammonia according to the inside temperature of the particulate filter 60, the NOx slip characteristics of the LNT 40 at the rich air/fuel ratio, and so on may be stored as maps through various experiments.

In addition, the controller 70 controls regeneration of the particulate filter 60 and desulfurization of the LNT 40.

The controller 70 can be realized by one or more processors activated by a predetermined program, and the predetermined program can be programmed to perform each step of a method of purifying exhaust gas according to an exemplary embodiment of the present invention.

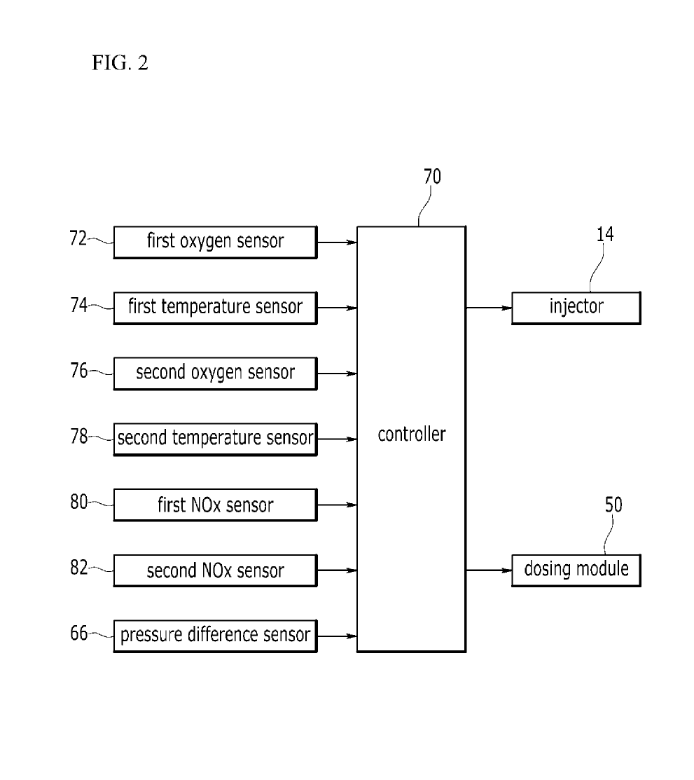

FIG. 2 is a block diagram illustrating a relationship of an input and output of a controller used in a method of purifying exhaust gas according to an exemplary embodiment of the present invention.

As shown in FIG. 2, the first oxygen sensor 72, the first temperature sensor 74, the second oxygen sensor 76, the second temperature sensor 78, the first NOx sensor 80, the second NOx sensor 82, and the pressure difference sensor 66 are electrically connected to the controller 70, and transmit the detected values to the controller 70.

The first oxygen sensor 72 detects the oxygen amount in the exhaust gas passing through the exhaust gas recirculation apparatus 30 and transmits the signal corresponding thereto to the controller 70. The controller 70 may perform the lean/rich control of the exhaust gas based on the oxygen amount in the exhaust gas detected by the first oxygen sensor 72. The detected value by the first oxygen sensor 72 may be represented as lambda (λ). The lambda means a ratio of actual air amount to stoichiometric air amount. If the lambda is greater than 1, the air/fuel ratio is lean. On the contrary, the air/fuel ratio is rich if the lambda is smaller than 1.

The first temperature sensor 74 detects the temperature of the exhaust gas passing through the exhaust gas recirculation apparatus 30 and transmits the signal corresponding thereto to the controller 70.

The second oxygen sensor 76 detects the oxygen amount in the exhaust gas flowing into the particulate filter 60 and transmits the signal corresponding thereto to the controller 70.

The second temperature sensor 78 detects the temperature of the exhaust gas flowing into the particulate filter 60 and transmits the signal corresponding thereto to the controller 70.

The first NOx sensor 80 detects the NOx amount contained in the exhaust gas flowing into the particulate filter 60 and transmits the signal corresponding thereto to the controller 70.

The second NOx sensor 82 detects the NOx amount contained in the exhaust gas exhausted from the particulate filter 60 and transmits the signal corresponding thereto to the controller 70.

The pressure difference sensor 66 detects the pressure difference between a front end portion and a rear end portion of the particulate filter 60 and transmits the signal corresponding thereto to the controller 70.

The controller 70 determines the driving condition of the engine, fuel injection amount, fuel injection timing, fuel injection pattern, injection amount of the reducing agent, regeneration timing of the particulate filter 60, and desulfurization timing of the LNT 40 based on the transmitted value, and outputs a signal for controlling the injector 14 and the dosing module 50 to the injector 14 and the dosing module 50.

Meanwhile, a plurality of sensors other than the sensors illustrated in FIG. 2 may be mounted in the system of purifying exhaust gas according to the exemplary embodiment of the present invention. For better comprehension and ease of description, however, description of the plurality of sensors will be omitted.

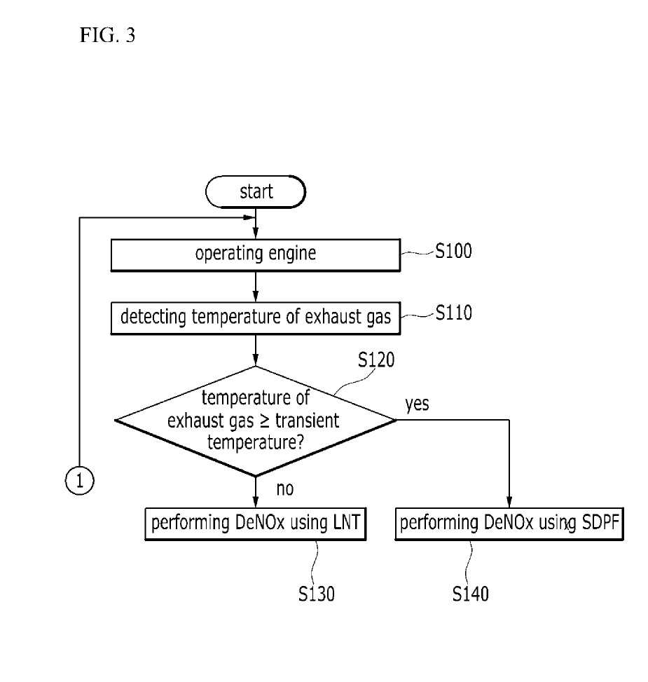

Hereinafter, referring to FIG. 3 to FIG. 6, a method of purifying exhaust gas according to an exemplary embodiment of the present invention will be described in detail.

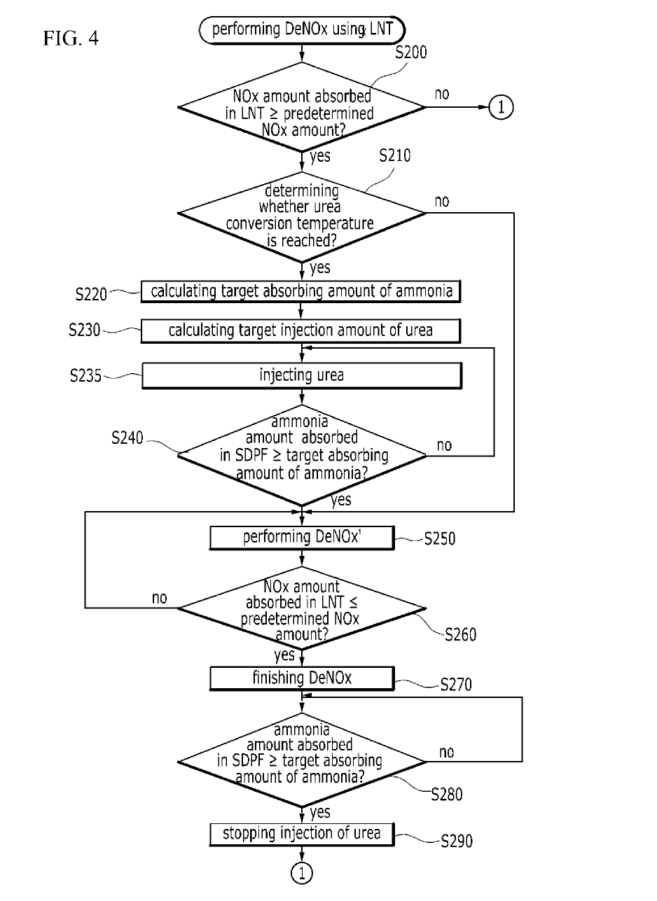

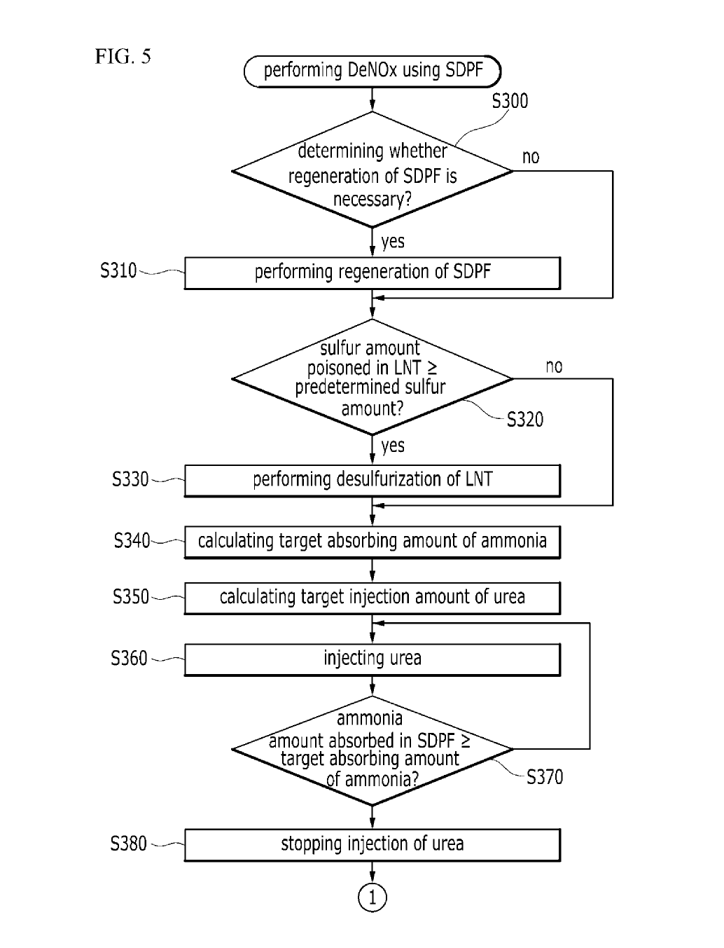

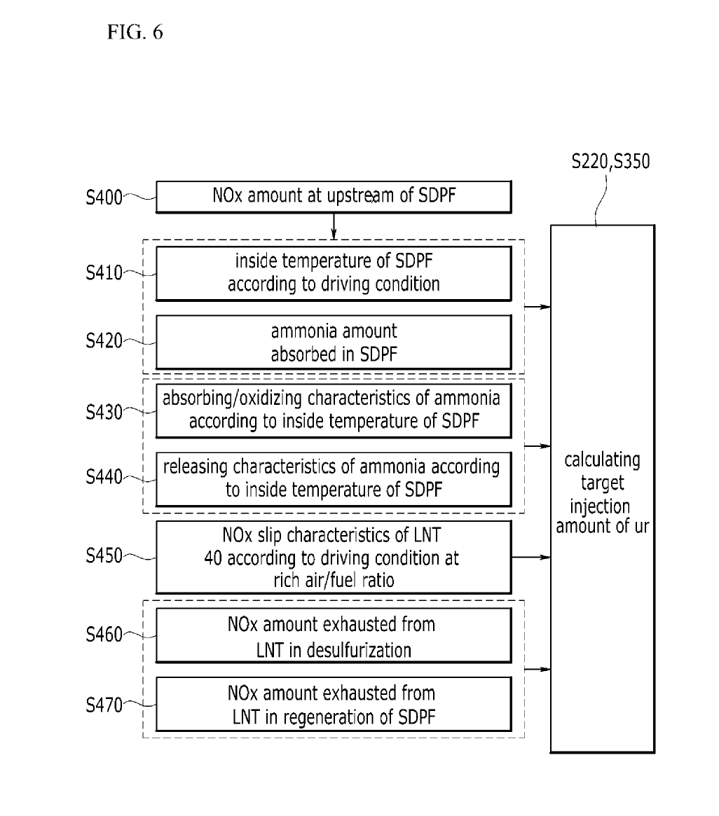

FIG. 3 is a flowchart of a method of purifying exhaust gas according to an exemplary embodiment of the present invention, FIG. 4 is a flowchart of a DeNOx method using an LNT in a method of purifying exhaust gas according to an exemplary embodiment of the present invention, FIG. 5 is a flowchart of a DeNOx method using an SDPF in a method of purifying exhaust gas according to an exemplary embodiment of the present invention, and FIG. 6 is a block diagram of a method of calculating target injection amount of urea in a method of purifying exhaust gas according to an exemplary embodiment of the present invention.

As shown in FIG. 3, the method of purifying exhaust gas according to the exemplary embodiment of the present invention is executed during operation of the engine 10 at step S100. If the engine 10 is operated, the exhaust gas is generated. The generated exhaust gas is purified through the method of purifying exhaust gas according to the exemplary embodiment of the present invention. In addition, the nitrogen oxide contained in the exhaust gas is absorbed in the LNT 40 at cold start or when the temperature of the exhaust gas is low.

If the engine 10 is operated, the first temperature sensor 74 and the second temperature sensor 78 detect the temperature of the exhaust gas at a specific point of the exhaust pipe 20 at step S110. Herein, the temperature of the exhaust gas may be value detected by the first temperature sensor 74, value detected by the second temperature sensor 78, or the temperature of the exhaust gas at the specific point calculated based on the values detected by the first and second temperature sensors 74 and 78. That is, the temperature of the exhaust gas is selected among the temperatures according to intention of a person of an ordinary skill in the art. For convenience of description, the temperature of the exhaust gas will mean the temperature of the exhaust gas flowing into the particulate filter 60 which is detected by the second temperature sensor 78 in this specification. However, the temperature of the exhaust gas is not limited to the temperature of the exhaust gas flowing into the particulate filter 60.

If the temperature of the exhaust gas is detected, the controller 70 determines whether the temperature of the exhaust gas is higher than or equal to transient temperature at step S120. Herein, the transient temperature may change according to the selection of the temperature of the exhaust gas. For example, the temperature detected by the second temperature sensor 78 is selected as the temperature of the exhaust gas, the transient temperature may be, but be not limited to, 250° C.

If the temperature of the exhaust gas is lower than the transient temperature at the step S120, the controller 70 performs DeNOx using the LNT 40 at step S130. On the contrary, if the temperature of the exhaust gas is higher than or equal to the transient temperature, the controller 70 performs DeNOx using the particulate filter 60, particularly the SDPF 62 at step S140.

Referring to FIG. 4, the DeNOx using the LNT 40 will be described in detail.

If the DeNOx using the LNT 40 begins, the controller 70 determines whether the NOx amount absorbed in the LNT 40 is greater than or equal to predetermined NOx amount at step S200.

If the NOx amount absorbed in the LNT 40 is less than the predetermined NOx amount, the controller 70 returns to the step S100 because the NOx absorbed in the LNT 40 do not need to be purified.

If the NOx amount absorbed in the LNT 40 is greater than or equal to the predetermined NOx amount, the controller 70 determines whether the temperature of the exhaust gas reaches urea conversion temperature at step S210. Herein, the urea conversion temperature, the same as the transient temperature, may change according to the selection of the temperature of the exhaust gas. For example, the temperature detected by the second temperature sensor 78 is selected as the temperature of the exhaust gas, the urea conversion temperature may be, but be not limited to, 180° C.

If the temperature of the exhaust gas does not reach to the urea conversion temperature at the step S210, the controller 70 proceeds to step S250.

If the temperature of the exhaust gas reaches the urea conversion temperature at the step S210, the controller 70 calculates target absorbing amount of the ammonia at step S220. Herein, the target absorbing amount of the ammonia is absorbing amount of the ammonia necessary to reduce the nitrogen oxide slipped from the LNT 40 in the SDPF 62 when the nitrogen oxide absorbed in the LNT 40 is released and reduced by controlling the air/fuel ratio to be rich.

That is, when the nitrogen oxide is reduced in the LNT 40, a portion of the nitrogen oxide is not reduced in the LNT 40 and is slipped from the LNT 40. If the ammonia is not absorbed in the SDPF 62 in advance, the slipped nitrogen oxide is not purified but is exhausted to the exterior of the vehicle. Therefore, the nitrogen oxide slipped from the LNT 40 can be purified by absorbing the ammonia in the SDPF 62 in advance.

Meanwhile, if the temperature of the exhaust gas does not reach the urea conversion temperature, the supplied urea may not be converted into the ammonia. Therefore, the urea is injected and the ammonia is absorbed in the SDPF 62 in advance only if the temperature of the exhaust gas is higher than or equal to the urea conversion temperature.

If the target absorbing amount of the ammonia is calculated, the controller 70 calculates target injection amount of the urea according to the target absorbing amount of the ammonia at step S230. Calculation of the target injection amount of the urea will be described in detail with reference to FIG. 6.

The first NOx sensor 80 detects the NOx amount at the upstream of the SDPF 62 at step S400. In addition, the controller 70 detects the inside temperature of the SDPF 62 according to the driving condition based on the detected values of the sensors including the first and second temperature sensors 74 and 78 at step S410, and predicts ammonia amount absorbed in the SDPF 62 at step S420. In order to predict the ammonia amount absorbed in the SDPF 62, the controller 70 utilizes the absorbing/oxidizing characteristics of the ammonia according to the inside temperature of the SDPF 62 and the releasing characteristics of the ammonia according to the inside temperature of the SDPF 62 at steps S430 and S440. That is, the ammonia amount currently absorbed in the SDPF 62 may be predicted from the ammonia amount that was previously absorbed in the SDPF 62, the ammonia amount that is currently being absorbed in the SDPF 62, the ammonia amount that is currently being oxidized in the SDPF 62, and the ammonia amount that is currently being released from the SDPF 62.

In addition, the controller 70 predicts the NOx amount slipped when the nitrogen oxide is reduced in the LNT 40 by using the NOx slip characteristics of the LNT 40 at step S450 under the condition where the air/fuel ratio of the engine is controlled to be rich in order to release/reduce the NOx absorbed in the LNT 40.

Further, the controller 70 predicts the NOx amount exhausted from the LNT 40 in desulfurization at step S460 and the NOx amount exhausted from the LNT 40 in regeneration of the particulate filter 60 at step S470.

After that, the controller 70 calculates the target injection amount of the urea at the step S230 and step S350 based on the values calculated or predicted at the steps S400 to S470. At the step S230, the target injection amount of the urea may be calculated the values calculated or predicted at the steps S400 to S450. At the step S350, the target injection amount of the urea may be calculated the values calculated or predicted at the steps S400 to S470.

As described above, the values calculated or predicted at the steps S400 to S470 may be predetermined according to the driving condition through various experiments.

If the target injection amount of the urea is calculated at the step S230, the controller 70 controls the dosing module 50 to inject the urea according to the target injection amount of the urea at step S235.

After that, the controller 70 determines whether the ammonia amount absorbed in the SDPF 62 is greater than or equal to the target absorbing amount of the ammonia at step S240. If the ammonia amount absorbed in the SDPF 62 is less than the target absorbing amount of the ammonia, the controller 70 controls the dosing module 50 to inject the urea continuously at the step S235. The ammonia for purifying the NOx slipped from the LNT 40 at the rich air/fuel ratio can be absorbed in the SDPF 62 in advance through the steps S210 to S240.

If the ammonia amount absorbed in the SDPF 62 is greater than or equal to the target absorbing amount of the ammonia, the controller 70 performs the DeNOx at the step S250. That is, the controller 70 controls the injector 14 to increase the fuel injection amount so as to cause the combustion environment to be rich. Therefore, the NOx absorbed in the LNT 40 is released and the NOx released from the LNT 40 and the NOx contained in the exhaust gas are reduced in the LNT 40. The carbon monoxide and the hydrocarbon contained in the exhaust gas may be oxidized in this process. In addition, the NOx slipped from the LNT 40 may be reduced in the SDPF 62 by the ammonia absorbed in the SDPF 62 in advance.

After that, the controller 70 determines whether the NOx amount absorbed in the LNT 40 is smaller than or equal to predetermined NOx amount at step S260. The predetermined NOx amount at the step S260 may be smaller than the predetermined NOx amount at the step S200.

If the NOx amount absorbed in the LNT 40 is greater than the predetermined NOx amount at the step S260, the controller 70 returns to the step S250 and performs the DeNOx.

If the NOx amount absorbed in the LNT 40 is smaller than the predetermined NOx amount at the step S260, the controller 70 finishes the DeNOx at step S270.

After that, the controller 70 determines whether the ammonia amount absorbed in the SDPF 62 is greater than or equal to the target absorbing amount of the ammonia at step S280. If the DeNOx is finished, the NOx is hardly to be slipped to the SDPF 62 because the LNT 40 absorbs the NOx. Therefore, the controller 70 determines whether the urea injection is stopped according to the ammonia amount absorbed in the SDPF 62. That is, the controller 70 continues to inject the urea until the ammonia amount absorbed in the SDPF 62 is greater than or equal to the target absorbing amount of the ammonia at the step S280.

If the ammonia amount absorbed in the SDPF 62 is greater than or equal to the target absorbing amount of the ammonia at the step S280, the controller 70 stops the urea injection at step S290 and returns to the step S100.

Hereinafter, referring to FIG. 5, the DeNOx using the SDPF 62 will be described in detail.

If the DeNOx using the SDPF 62 is begun, the controller 70 determines whether the regeneration of the SDPF 62 is necessary based on the value detected by the pressure difference sensor 66 at step S300. That is, the pressure difference detected by the pressure difference sensor 66 is larger than or equal to the predetermined pressure.

If the regeneration of the SDPF 62 is necessary at the step S300, the controller 70 performs the regeneration of the SDPF 62 at step S310 and proceeds to step S320. That is, the controller 70 controls the exhaust gas not to be recirculated and controls the injector 14 to post-inject the fuel. Therefore, the temperature of the exhaust gas is raised. Therefore, the particulate matter trapped in the SDPF 62 is burnt.

Meanwhile, if the exhaust gas is not recirculated, the NOx amount in the exhaust gas increases. In addition, if the temperature of the exhaust gas is raised, the NOx is not absorbed nor purified in the LNT 40. Therefore, the NOx amount exhausted from the LNT 40 in the regeneration of the SDPF 62 should be considered when calculating the target injection amount of the urea (referring to FIG. 6).

If the regeneration of the SDPF 62 is not necessary at the step S300, the controller 70 determines whether sulfur amount poisoned in the LNT 40 is greater than or equal to predetermined sulfur amount at step S320. That is, it is determined whether the desulfurization of the LNT 40 is necessary.

If the sulfur amount poisoned in the LNT 40 is greater than or equal to the predetermined sulfur amount at the step S320, the desulfurization of the LNT 40 is performed at step S330 and the controller 70 proceeds to step S340. That is, the controller 70 controls the injector 14 to post-inject the fuel so as to raise the temperature of the exhaust gas. In addition, the fuel amount injected by the injector 14 is so controlled that the rich air/fuel ratio and the lean air/fuel ratio are repeated.

Meanwhile, the LNT 40 cannot absorb the NOx if the temperature of the exhaust gas is high and the air/fuel ratio is lean, but a portion of the NOx is reduced in the LNT 40 if the air/fuel ratio is rich. Therefore, the NOx amount exhausted from the LNT 40 in desulfurization of the LNT 40 should be considered in calculating the target injection amount of the urea (referring to FIG. 6).

If the sulfur amount poisoned in the LNT 40 is less than the predetermined sulfur amount at the step S320, the controller 70 calculates the target absorbing amount of the ammonia at step S340 and calculates the target injection amount of the urea according to the target absorbing amount of the ammonia at step S350. The target absorbing amount of the ammonia at the step S340 means the absorbing amount of the ammonia necessary to reduce majority of the NOx contained in the exhaust gas in the SDPF 62. Therefore, the target absorbing amount of the ammonia at the step S340 may be different from the target absorbing amount of the ammonia at the step S210. In addition, the target injection amount of the urea at the step S350 may be calculated from the same method of calculating the target injection amount of the urea at the step S220. However, variables considered at the step S350 may be different from those considered at the step S220. That is, the NOx slip characteristics of the LNT 40 according to the driving condition is a major variable at the step S220, but the NOx amount exhausted from the LNT 40 in the desulfurization or the NOx amount exhausted from the LNT 40 in the regeneration of the SDPF 62 may be a major variable at the step S350.

If the target injection amount of the urea is calculated at the step S350, the controller 70 controls the dosing module 50 to inject the urea according to the target injection amount of the urea at step S360. Therefore, the NOx contained in the exhaust gas is reduced in the SDPF 62. At this time, the controller 70 controls the air/fuel ratio to be rich (λ>0.95) close to the stoichiometric air/fuel ratio so as to release the NOx absorbed in the LNT 40 and to purify the released NOx in the SDPF 62. Therefore, fuel consumption due to control of the air/fuel ratio may be prevented.

After that, it is determined whether the ammonia amount absorbed in the SDPF 62 is greater than or equal to the target absorbing amount of the ammonia a step S370. Generally, the ammonia generated by injecting the urea is used to reduce the NOx as soon as the ammonia is absorbed in the SDPF 62 or without being absorbed in the SDPF 62 while the DeNOx using the SDPF 62 is performed. Therefore, the ammonia amount absorbed in the SDPF 62 is hard to reach the target absorbing amount of the ammonia. However, the NOx may be generated less than predicted NOx generation due to quick change of the driving condition. In this case, the ammonia amount absorbed in the SDPF 62 may reach the target absorbing amount of the ammonia and the urea injection is stopped so as to prevent unnecessary consumption of the urea. That is, if the ammonia amount absorbed in the SDPF 62 is greater than or equal to the target absorbing amount of the ammonia at the step S370, the controller 70 stops the urea injection at step S380 and returns to the step S100.

If the ammonia amount absorbed in the SDPF 62, on the contrary, is less than the target absorbing amount of the ammonia at the step S370, the controller 70 continues to control the dosing module 50 to inject the urea at the step S360. Therefore, the NOx contained in the exhaust gas is continuously reduced in the SDPF 62.

As described above, the system of purifying exhaust gas including the LNT and the SDPF may be efficiently controlled to improve purifying efficiency of the nitrogen oxide contained in the exhaust gas according to the exemplary embodiments of the present invention.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A system of purifying exhaust gas comprising:
an engine including an injector for injecting fuel thereinto, generating power by burning mixture of air and the fuel, and exhausting the exhaust gas generated at combustion process to an exterior thereof through an exhaust pipe;
a lean NOx trap (LNT) mounted on the exhaust pipe, and adapted to absorb nitrogen oxide (NOx) contained in the exhaust gas at a lean air/fuel ratio, to release the absorbed nitrogen oxide at a rich air/fuel ratio, and to reduce the nitrogen oxide contained in the exhaust gas or the released nitrogen oxide;
a dosing module mounted on the exhaust pipe and adapted to inject a reducing agent into the exhaust gas;
a selective catalytic reduction catalyst on a diesel particulate filter (SDPF) mounted on the exhaust pipe downstream of the dosing module and adapted to trap particulate matter contained in the exhaust gas and to reduce the nitrogen oxide contained in the exhaust gas using the reducing agent injected through the dosing module; and
a controller performing denitrification (DeNOx) using the LNT when temperature of the exhaust gas is lower than transient temperature, and performing denitrification using the SDPF when the temperature of the exhaust gas is higher than or equal to the transient temperature.

2. The system of claim 1, wherein the controller is adapted to control the air/fuel ratio to be rich so as for the LNT to remove the nitrogen oxide when the temperature of the exhaust gas is lower than the transient temperature and NOx amount absorbed in the LNT is greater than or equal to predetermined NOx amount.

3. The system of claim 2, wherein the controller controls the dosing module to inject the reducing agent when the temperature of the exhaust gas reaches urea conversion temperature such that the reducing agent is absorbed in the SDPF.

4. The system of claim 3, wherein amount of the reducing agent injected by the dosing module is determined based on inside temperature of the SDPF, amount of the reducing agent absorbed in the SDPF, absorbing/oxidizing characteristics of the reducing agent according to the inside temperature of the SDPF, releasing characteristics of the reducing agent according to the inside temperature of the SDPF, and NOx slip characteristics of the LNT under a condition where the air/fuel ratio of the engine is controlled to be rich so as to release/reduce the NOx absorbed in the LNT.

5. The system of claim 1, wherein the controller controls the air/fuel ratio to be rich close to stoichiometric air/fuel ratio when the temperature of the exhaust gas is higher than or equal to the transient temperature so as to release the NOx absorbed in the LNT, and controls the dosing module to inject the reducing agent so as to reduce the NOx released from the LNT or the NOx contained in the exhaust gas in the SDPF.

6. The system of claim 5, wherein amount of the reducing agent injected by the dosing module is determined based on inside temperature of the SDPF, amount of the reducing agent absorbed in the SDPF, absorbing/oxidizing characteristics of the reducing agent according to the inside temperature of the SDPF, releasing characteristics of the reducing agent according to the inside temperature of the SDPF, and NOx slip characteristics of the LNT according to a driving condition at the rich air/fuel ratio.

7. The system of claim 1, wherein the controller is adapted to raise the temperature of the exhaust gas so as to perform regeneration of the SDPF and to control the dosing module to inject the reducing agent so as for the SDPF to reduce the NOx contained in the exhaust gas when the regeneration of the SDPF is necessary.

8. The system of claim 7, wherein amount of the reducing agent injected by the dosing module is determined based on inside temperature of the SDPF, amount of the reducing agent absorbed in the SDPF, absorbing/oxidizing characteristics of the reducing agent according to the inside temperature of the SDPF, releasing characteristics of the reducing agent according to the inside temperature of the SDPF, NOx slip characteristics of the LNT according to a driving condition and the temperature of the exhaust gas at the rich air/fuel ratio, and NOx exhaust amount from the LNT when regenerating the SDPF.

9. The system of claim 1, wherein the controller is adapted to perform desulfurization of the LNT by repeating the rich air/fuel ratio and the lean air/fuel ratio and to control the dosing module to inject the reducing agent so as for the SDPF to reduce the NOx contained in the exhaust gas when the desulfurization of the LNT is necessary.

10. The system of claim 9, wherein amount of the reducing agent injected by the dosing module is determined based on inside temperature of the SDPF, amount of the reducing agent absorbed in the SDPF, absorbing/oxidizing characteristics of the reducing agent according to the inside temperature of the SDPF, releasing characteristics of the reducing agent according to the inside temperature of the SDPF, NOx slip characteristics of the LNT according to a driving condition at the rich air/fuel ratio, and NOx exhaust amount from the LNT when desulfurizing the LNT.

11. The system of claim 1, further comprising a mixer mounted on the exhaust pipe between the dosing module and the SDPF and mixing the reducing agent and the exhaust gas evenly.

12. The system of claim 1, wherein the SDPF further comprise an additional selective catalytic reduction catalyst (SCR) for reducing the nitrogen oxide contained in the exhaust gas using the reducing agent injected by the dosing module.

13. A method of purifying exhaust gas comprising:
detecting temperature of the exhaust gas;
comparing the temperature of the exhaust gas with transient temperature;
removing nitrogen oxide contained in the exhaust gas at a lean NOx trap (LNT) by controlling combustion environment when the temperature of the exhaust gas is lower than the transient temperature; and
removing the nitrogen oxide contained in the exhaust gas at a diesel particulate filter (SDPF) by injecting reducing agent when the temperature of the exhaust gas is higher than or equal to the transient temperature.

14. The method of claim 13, wherein the removal of the nitrogen oxide contained in the exhaust gas at the LNT is performed by controlling air/fuel ratio to be rich when NOx amount absorbed in the LNT is greater than or equal to predetermined NOx amount.

15. The method of claim 14, wherein the removal of the nitrogen oxide contained in the exhaust gas at the LNT, before controlling the air/fuel ratio to be rich, further comprises:
determining whether the temperature of the exhaust gas reaches urea conversion temperature;
determining target injection amount of the reducing agent when the temperature of the exhaust gas reaches the urea conversion temperature; and
injecting the reducing agent according to the target injection amount of the reducing agent.

16. The method of claim 15, wherein the target injection amount of the reducing agent is determined based on inside temperature of the SDPF, amount of the reducing agent absorbed in the SDPF, absorbing/oxidizing characteristics of the reducing agent according to the inside temperature of the SDPF, releasing characteristics of the reducing agent according to the inside temperature of the SDPF, and NOx slip characteristics of the LNT under a condition where the air/fuel ratio of the engine is controlled to be rich so as to release/reduce the NOx absorbed in the LNT.

17. The method of claim 13, wherein the removal of the nitrogen oxide contained in the exhaust gas at the SDPF comprises:
determining target injection amount of the reducing agent based on inside temperature of the SDPF, amount of the reducing agent absorbed in the SDPF, absorbing/oxidizing characteristics of the reducing agent according to the inside temperature of the SDPF, releasing characteristics of the reducing agent according to the inside temperature of the SDPF, and NOx slip characteristics of the LNT according to a driving condition at the rich air/fuel ratio; and
injecting the reducing agent according to the target injection amount of the reducing agent.

18. The method of claim 17, wherein the removal of the nitrogen oxide contained in the exhaust gas at the SDPF, before determining the target injection amount of the reducing agent, further comprises:
determining whether regeneration of the SDPF is necessary; and
performing the regeneration of the SDPF when the regeneration of the SDPF is necessary,
wherein the target injection amount of the reducing agent is determined by further considering NOx exhaust amount from the LNT when regenerating the SDPF.

19. The method of claim 17, wherein the removal of the nitrogen oxide contained in the exhaust gas at the SDPF, before determining the target injection amount of the reducing agent, further comprises:
determining whether desulfurization of the LNT is necessary; and
performing the desulfurization of the LNT when the desulfurization of the LNT is necessary,
wherein the target injection amount of the reducing agent is determined by further considering NOx exhaust amount from the LNT when desulfurizing the LNT.
